(19) United States
(12) Patent Application Publication
(10) Pub. No.: US 2020/0230790 A1
(43) Pub. Date: Jul. 23, 2020

(54) Color-Coded Method for Combination Wrenches

(71) Applicants: Pedro Rincon, Youngsville, NC (US); David Johnston, Clayton, NC (US)

(72) Inventors: Pedro Rincon, Youngsville, NC (US); David Johnston, Clayton, NC (US)

(21) Appl. No.: 16/250,083

(22) Filed: Jan. 17, 2019

(51) Int. Cl. B25B 23/16

(52) U.S. Cl. CPC B25B 23/16; B25B 13/56

(57) ABSTRACT

The combination key sets in mm fabrication are identified by a single color and SAE (American Standard) with a different color. Each Key has been printed in the number corresponding to the size of the logo with a different color for each color code. The Ratchet combination Key has an arrow and the numbers go in the same direction indicating the direction in which it should be used. On one side are green to tighten and on the other are red to loosen. Additionally, each key set has protective coverings that are also matched and coordinated by colors.

### INVENTION FIELD

The present invention relates to the identification for wrench-type tools and in particular, to a color-coding system used in wrench-type tools. The color-coding system is used in specifics with wrenches in which one end is open and the opposite end contains a ratchet; one end is open and the other close; both ends are open; lastly, both ends are closed.

### BACKGROUND OF THE INVENTION

The conventional way of marking tools such a wrench consists of printing on its surface the size of the nut that is attached to the mouth of the key, as well as the name of the manufacturer (or logo). This printing can be carried out in different ways, for example, stamping, printing, molding (identifier included in the mold used to mold the tool), stickers, etc.

The previously mentioned conventional marking form has disadvantages in terms of ease in reading the type of tool; due to that the mark, in general, it is not easily visible because there is no contrast of the number with the background on which it is printed, that is, the body of the tool, since both the number and the tool are the same color and material, usually metallic; in addition, the number can be greased or smudged by dirt, which makes it difficult to read.

In working conditions that can be of reduced illumination, or when using lamps with great flash is even more difficult to read because the material of the tool reflects the light making it necessary to move the tool to find a point of contrast that allows its reading.

On the other hand, in the individual ratchet type tools, the direction of rotation to be used is not usually included, which causes the operator to have to turn the tool or manipulate it to find the direction for its correct use, which in return hinders its operation.

Currently, there are three types of keys with 15 fixed-mouth nuts. The first is called a ratchet.

The ratchet uses a method of reversible type, which changes direction by means of a selected lever, and allows to tighten in both directions according to the position of the selected lever.

The second type of key is called a mixed-mouth wrench combination and it is as shown in figure IB. This key is open at one end and closed at the other.

As mentioned above, the ratchet set can also have both ends open, or both ends closed.

The third type of key is fixed at one end with an open mouth and has a ratchet at the closed end of the tool. In this type of key, the ratchet is not reversible.

### DESCRIPTION OF THE INVENTION

The present invention relates to a wrench with color coding. Again, there are four ways in which the wrench set can be made—one in which one end is open and the other end contains a ratchet, one end open and the opposite side closed, both ends open; and lastly, with both ends closed. The wrench uses a color-coding system for easy identification of the nut sizes that each key can manipulate.

The ratchet associated with the wrench is a mechanism that allows a nut or gear to turn into a single direction, while preventing you from doing so in the contrary; to perform this function of no rotation in the opposite direction, the ratchet makes use of teeth.

The ratchet allows you to use the tool to tighten (or to release) a nut without decoupling the tool from the nut, that is, once the nut is engaged. Since the ratchet is not reversible, the tool must be rotated approximately 180 degrees according to whether it wants to tighten or release the corresponding nut.

The present invention consists of a wrench in four different modalities:

a) spanner in which one end is open and the other end contains a ratchet;
b) spanner in which both ends are open;
c) spanner in which both ends are closed; and
d) wrench where one end is open and the other closed.

The wrenches in which one end is open and the other end contains a ratchet, uses a color-coded identification system and an indicator to identify the sense in which it will be used; green to tighten or red to loosen up.

The wrenches according to the invention have their own color within each structure. The wrenches contain identified measurements that represent the nut that the key can manipulate corresponding to:

a) SAE (Society of Automotive Engineers—Society of Automotive Engineers), which is given in fractions or units of inch; and
b) metric system which is given in millimeters (mm).

The purpose of this invention is for the key to identify each number of nut size and/or logo with one color that is different from the one found in the structure of the key.

In general, the color code is:
If the key uses the metric system, the color of the central part of it or its cover will be blue, or any color.
If the key uses the SAE system, the color of the central part of it or its cover will be white, or any color.
For ratchet wrenches, if the key is used to tighten the nut, it will be printed in green.
For ratchet wrenches, if the key is used to loosen the nut, it will be printed in red.

The above color codes allow one to easily identify the direction in which to rotate the tool.

In addition to the colors used to identify the direction in which to turn, the key is printed on the size of the nut it manipulates, as well as a space to define the name of the manufacturer and an indicator showing in what sense it must be used.

This impression is made in such a way that the name of the manufacturer, the size number of the key and the indicator match the direction of rotation of the key in its sheath.

In the keys without a ratchet, the color code can go directly on the key or in the case. The color can be the same in the number and in the logo or brand of manufacturer. In the keys without a ratchet the size of each key has its own color code for the number and logo or brand of maker.

### LIST OF ELEMENTS IN THE INVENTION

Key with color coding (100)
Closed mouth (105)
Fixed mouth (110)
Ratchet (120)
Colored handle (130)
Direction of rotation indicator (150)
Logo (160)
Number identifying the size of the nut that manipulates the color key (170)

### LIST OF FIGURES

The present descriptive memory is complemented with a set of illustrative drawings of the preferred example and never limitative of the invention.

FIG. 1 shows a perspective view of the fixed mouth key with ratchet with its characteristic elements.

FIG. 2 shows a front and back view of the fixed mouth key with ratchet with its characteristic elements.

FIG. 3 shows a front and back view of some ratchet keys of different sizes, in system metric and SAE according to the color printed or painted on the basic material of the key.

FIG. 4 shows a front view of some fixed mouth keys without ratchet with sleeve of different sizes with SAE measurement units.

FIG. 5 shows a front view of some fixed mouth keys without ratchet of different sizes with units of measure in metric system and SAE.

### DETAILED DESCRIPTION OF THE INVENTION

The present invention relates to a system of color coding in a key with color coding (100) characterized in that in its central part, the key (100) has one color (130).

The purpose of the present invention is to expedite the use of a key and in particular, a key with coding of color (100) by means of the use of a code of colors.

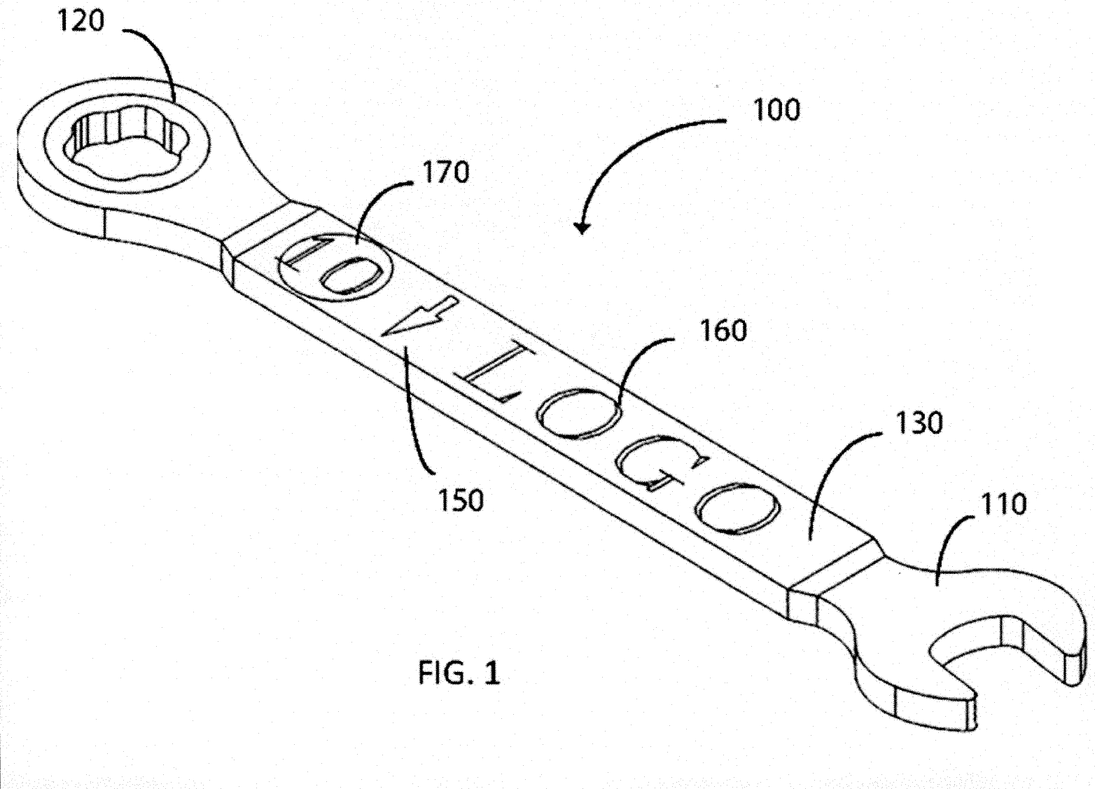

A first embodiment of the invention is shown in FIG. 1.

FIG. 1 illustrates the key with color coding (100) which has one end with a fixed mouth (110) and the other with ratchets (120); the base color, located in the central part of the key (100), it is identified with the number (130) and denominates handle of color.

More particularly, in FIG. 1 it can be seen that the key with color coding (100) has a number nut size identifier that manipulates the key and it is identified in this text with the number (170). This number nut size identifier (170) is arranged in the colored grip (130).

Likewise, in order to solve the problems of identification of the direction in which a key must be turned or key, the inventor proposes that the key with coding (100) shown in FIG. 1 that has one end a ratchet (120) also has in its central part and about the colored handle (130) an indicator of the direction of turn (150).

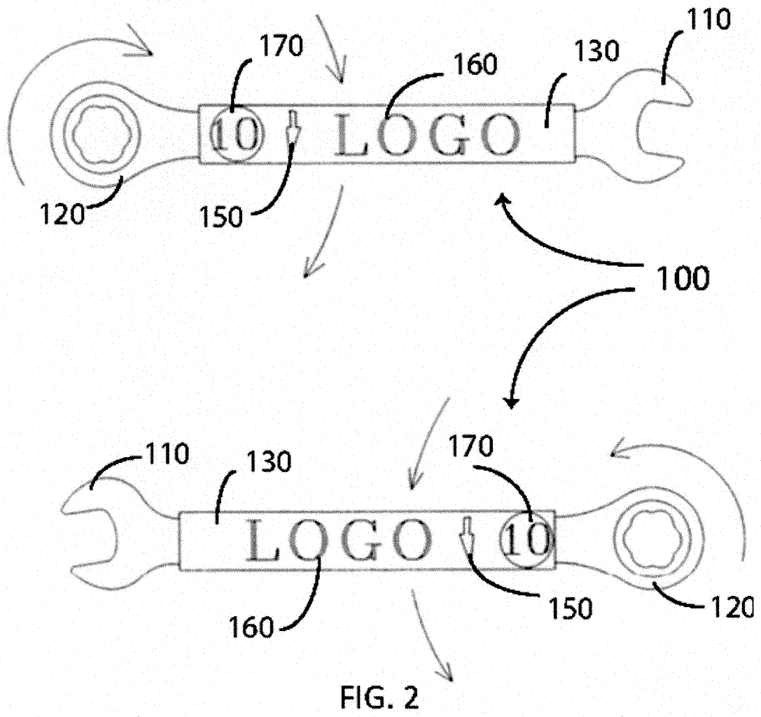

FIG. 2 shows a front and back view of the key with color coding (100) that has a fixed mouth (110) and at the other end it carries a ratchet (120); a colored grip (130) can be any color different to green or red.

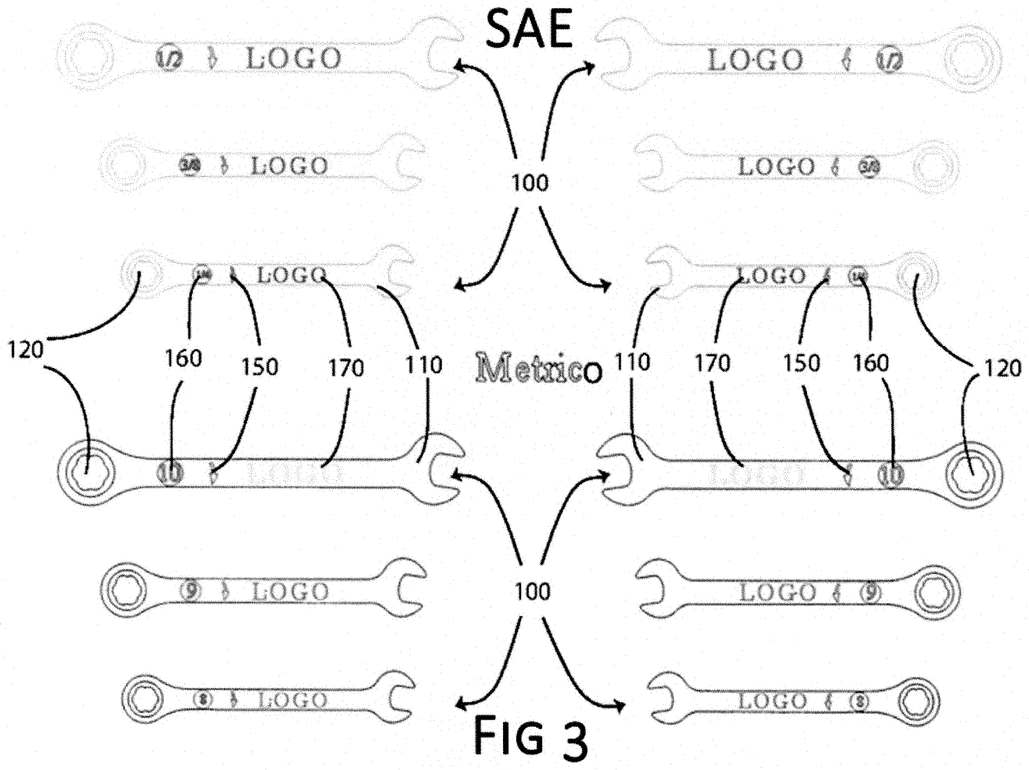

The keys have different sizes according to the nut that it is manipulating. The size of the key (and therefore the nut) is identified with a numeric code, SAE and metric (mm). Examples of these keys are shown in FIG. 3, where the metric system is identified in dark color and the SAE system in clear color.

In the same FIG. 3 it can be seen that the key with color coding (100) of the invention is characterized because the elements: size identifier number of nut that manipulates the key in color (170); indicator of direction of rotation (150); and space for the logo (160) are all the same color, all this according to the color code established for this type of key.

All the elements mentioned above can be printed on both sides or sides of the key with color coding (100) and in particular, it is intended that both sides have: the size identifier number of nut that manipulates the key in color (170); indicator 30 of the direction of rotation (150); and space for the logo (160), such and as seen in FIG. 3.

In a first modality of the invention, the handle of color (130) is printed directly on the key (100) by any suitable means of printing or painting. This modality is appreciable in FIG. 3.

In a preferred modality of the invention, the inventor has chosen the color blue so that it is the handle of color (130) in case of identifying the keys with SAE system. However, the manufacturer can change the grip of color (130) for one that suits best.

On the other hand, only by way of example, white has been chosen to be the color of the colored grip (130) in case the keys with metric system international. However, the manufacturer can change the color of the colored handle (130) for one that suits best.

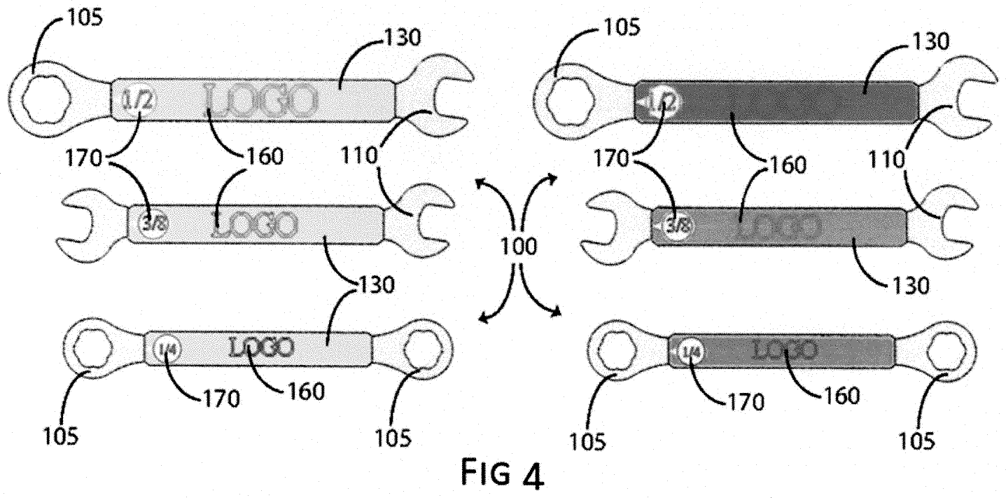

FIG. 4 shows a front view of some fixed mouth keys (110) without ratchet of different sizes with SAE measurement units, showing modalities of the invention in which the colored handle (130) is made in 20 a cover that is placed over the key (100).

The cover that is installed on the key (100) is made of plastic, rubber, polyurethane or any other material available and it can be seen installed in FIG. 4.

In one modality of the invention, the colored grip (130) has the same color as the identifier number of the size of nut that manipulates the key (170) and the logo (160). All this according to the color code set for this type of keys.

In another modality of the invention, the colored handle (130) has a different color (in this yellow example) at of the identifier number of the nut size that manipulates the key (170) and the logo (160). All this according to color code set for this type of keys.

The color code shown in FIG. 4 corresponds to table in FIG. 4A.

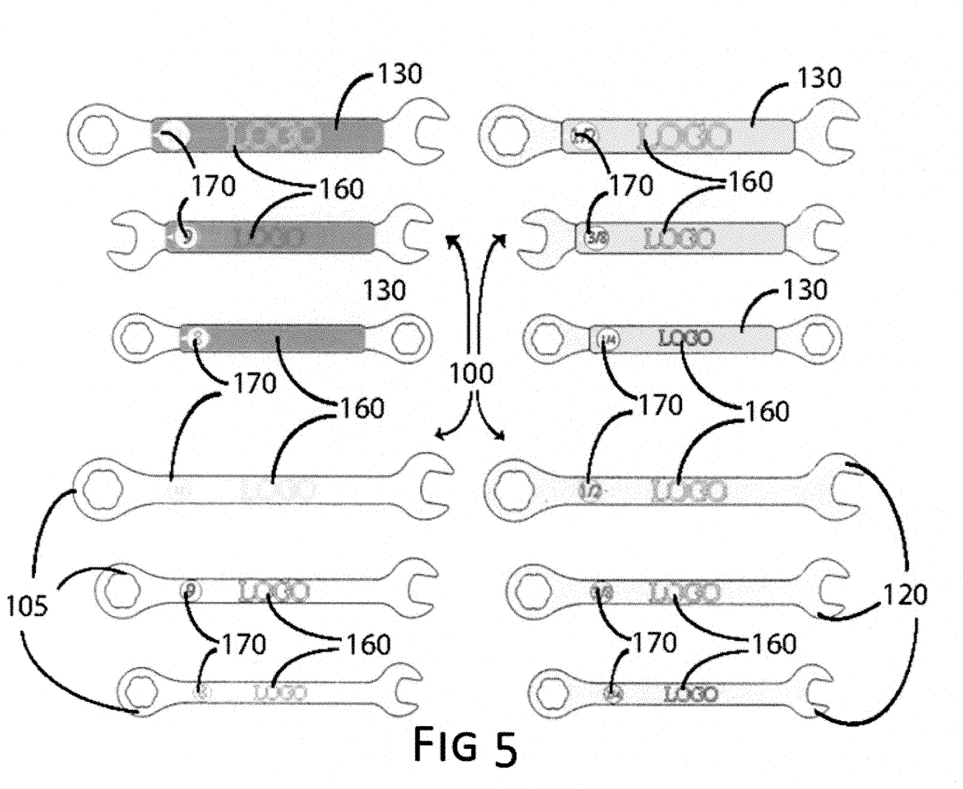

FIG. 5 shows a front view of some fixed mouth keys without ratchet of different sizes with units of measure in metric system and SAE. In this FIG. 5 both modalities can be appreciated where the hilt of color (130) is a sleeve or is printed directly on the key (100).

The basic colors of manufacture of the key can be chromed, anodized or painted; in this example the color basic manufacturing for the keys identified with the metric system is white and for the identified keys with the SAE system, this color is brown.

In FIG. 5, the color code for the keys according to the metric system corresponds with the table found in FIG. 5A.

For the assignment of the colors to identify the upper and intermediate nut sizes to those shown in the previous tables, it starts again from the colors used to identify smaller sizes of nut. However, the manufacturer can change the color of the nut size identifier number that manipulates the color key (170) for the one that suits best.

In another embodiment of the invention, the fixed-mouth wrench (100) can have both ends open (110), both closed ends (105) or one open end (110) and another closed (105) or an open end (110) and another end with ratchet (120).

### INDUSTRIAL APPLICATION OF THE INVENTION

The present invention is intended to be implemented in the keys to speed up their use and quality of production.

Table in reference to Figure IV:

| Nut size (SAE) | Number color (170) and logo (160) |
|---|---|
| ¼ | Blue |
| ⅜ | Red |
| ½ | Green |

Table in reference to Figure V:

| Nut size (MM) | Number color (170) and logo (160) |
|---|---|
| 8 | Coffee |
| 9 | Purple |
| 10 | Green |
| 11 | Yellow |

### Color Code

### Inches

Rose=⅛

Blue=¼

Pink= 5/16

Black= 11/32

Red=⅜

White= 7/16

Green=½

Maroon= 9/16

Gold=⅝

Orange=¾

Copper=⅞

Lime= 13/16

For the following sizes you start with the first colors.

For intermediate sizes it is left at the discretion of the manufacturer.

### Color Code

### MM

### Tan=5

### Magnesia=6

### Silver=7

### Brown=8

### Purple—9

### Yellow=10

### Lavender=12

### Peach=14

### Cardinal=15

### Violet=17

### Aqua=18

Light blue=20

For the following sizes you start with the first colors.

For intermediate sizes it is left at the discretion of the manufacturer.

1. A key with color coding (100) with ratchet (120) or without ratchet characterized because in its central part, it has a handle (130) of color.

2. The key with color coding (100) of claim 1, characterized because the color handle (130) is printed or painted directly on the key (100).

3. The color-coded key (100) with ratchet (120) of claim 1, characterized because the color handle (130) has a different color to green or red.

4. The key with color coding (100) of claim 1, characterized because the color of the handle (130) of color is blue or any other for the SAE system.

5. The key color coding (100) of claim 1, characterized because the color of the handle (130) of color is white or any other for the international metric system.

6. The color-coded key (100) of claim 1, characterized because its central part and on the colored handle (130) it has a nut size identifier which manipulates the color key (170).

7. The key with color coding (100) with ratchet (120) of claim 1, characterized because its central part and on the handle (130) of color has an indicator of the direction of rotation (150).

8. The key with color coding (100) of claim 1, characterized because its central part and on the handle (130) color has a logo (160)

9. The color-coded key (100) of claim 1 without a pawl, characterized because the SAE system, the color for the nut size identifier number manipulating the color key (170) and logo (160) corresponds with the following table:

10. The color-coded key (100) of claim 1 without a pawl, characterized because the metric system, the color for the nut size identifier number manipulating the color key (170) and logo (160) corresponds with the following table:

11. The key with color coding (100) of the preceding claims characterized because the elements: nut size identifier number manipulated by the color key (170); direction of rotation indicator (150); and logo (160) are on both sides of the key (100).

12. The key with color coding (100) of the preceding claims, characterized because the elements: number identifying the size of the nut manipulated by the color key (170);
direction of rotation indicator (150); and space for the manufacturer's logo (160) are all the same color.

13. The key with color coding (100) of claim 1, characterized because both ends of the key are of fixed mouth (110).

14. The key with color coding (100) of claim 1, characterized because both ends of the key are closed mouth (105).

15. The key with color coding (100) of claim 1, characterized because one of its ends is of a fixed mouth (110) and the other end is of a closed mouth (105).

16. The key with color coding (100) of claim 1, characterized because one of its ends has a fixed mouth (110) and the other end has a ratchet (120).

17. The fixed key with ratchet with color coding (100) of claim 16, characterized because the elements: number identifying the size of the nut manipulated by the color key (170); direction of rotation indicator (150); and space for the manufacturer's logo (160) they are written in green color for the squeeze function and in red color for the loosening function.

18. The fixed key with color-coded ratchet (100) of claim 16, characterized because the elements: number identifying the size of the nut manipulated by the color key (170); direction of rotation indicator (150); and space for the manufacturer's logo (160) can be read in front to indicate which function you want to use, green for the squeeze function and red for the loosening function.

19. The color-coded key (100) of the preceding claims, characterized because the color handle (130) is a cover with the color code that is installed on the key (100).

20. The key with color coding (100) of claim 19, characterized because the cover that is installed on the key (100) is of a material selected from the group comprising: plastic, rubber, polyurethane or any other available material.

21. The color-coded key (100) of claim 1, characterized because the color grip (130) has the same color as the nut size identifier that manipulates the key (170) and the logo (160).

22. The color-coded key (100) of claim 1, characterized because the color handle (130) has a different color from the nut size identifier number manipulated by the key (170) and the logo (160).
Chart in reference to claim #9:

| Nut size (SAE) | Number color (170) and logo (160) |
|---|---|
| ¼ | Blue |
| ⅜ | Red |
| ½ | Green |

Chart in reference to claim #10:

| Nut size (MM) | Number color (170) and logo (160) |
|---|---|
| 8 | Coffee |
| 9 | Purple |
| 10 | Green |
| 11 | Yellow |
